(19) United States
(12) Patent Application Publication
(10) Pub. No.: US 2017/0221129 A1
(43) Pub. Date: Aug. 3, 2017

(54) SYSTEM, METHOD, AND NON-TRANSITORY COMPUTER-READABLE STORAGE MEDIA FOR CREATING A MEAL PLAN

(71) Applicant: Wal-Mart Stores, Inc., Bentonville, AR (US)

(72) Inventor: Justin Toupin, San Francisco, CA (US)

(21) Appl. No.: 15/009,654

(22) Filed: Jan. 28, 2016

(51) Int. Cl. G06Q 30/06; G06Q 10/08

(52) U.S. Cl. CPC G06Q 30/0633; G06Q 10/087

(57) ABSTRACT

A system for creating a meal plan includes a networked computer system including a business server computer and database for storing customer purchase history data and recipe data. The system further includes a mobile computing device coupled to the networked computer system. The mobile computing device includes a memory for storing an application and a processor for executing the application which causes the processor to identify a customer, obtain customer purchase history from the business database, analyze the customer purchase history data to obtain a customer budget, and create a meal plan including meals that collectively have a price falling within the customer budget. Each meal of the meal plan is defined by a recipe requiring items for carrying out the recipe. Also disclosed herein are methods for creating a meal plan and non-transitory computer-readable storage media for creating a meal plan.

### FIELD OF THE DISCLOSURE

U.S. Patent Classification Primary Class: 707 (DATA PROCESSING: DATABASE, DATA MINING, AND FILE MANAGEMENT OR DATA STRUCTURES). Art Unit: 2161.

The present disclosure relates generally to weekly meal planners, and more particularly, to systems, methods, and non-transitory computer-readable storage media for creating a meal plan.

### BACKGROUND

With demanding work schedules, school schedules, and/or planned daily activities, time is often limited for planning and preparing home-cooked meals on a daily basis. Planning and preparing a meal typically entails obtaining a recipe, shopping for the necessary ingredients or items required by the recipe, and setting aside an ample amount of time to prepare the meal.

Typically, the person planning and preparing the meal also takes into account a variety of meal planning constraints, such as food preference constrains, budget constraints, and/or various dietary constraints (such as food allergies, food intolerances, and/or health issues of person(s) who may be eating the meal). For example, the person planning and preparing the meal may have to forego a certain recipe, because the recipe requires an ingredient that a person eating the meal may be allergic to. In another example, the person planning and preparing the meal may have to forego a certain recipe, because the recipe requires ingredients that collectively cost more than what was budgeted for the meal. In another example, the person planning and preparing the meal may have to forego a certain recipe, because the recipe contains ingredients that a person(s) eating the meal dislikes. In addition, many people may also have a limited amount of time to shop for the ingredients required for preparing the meal. As a result, many people may elect to enjoy a more expensive and potentially less nutritious restaurant prepared and/or take-out meal.

The present disclosure is aimed at solving the problems identified above.

### SUMMARY

In different embodiments of the present disclosure, systems, methods, and non-transitory computer-readable storage media for creating a meal plan.

In one embodiment of the present disclosure, a system for creating a meal plan is provided. The system comprises a server computer of a business and a business database coupled to the server computer of the business for storing customer purchase history data and recipe data. The system further comprises a mobile computing device coupled to the server computer of the business. The mobile computing device includes a memory for storing an application containing computer-executable instructions and a processor coupled to the memory for executing the computer-executable instructions of the application. The executing of the computer-executable instructions causes the processor to: identify a customer; obtain customer purchase history of the customer from the business database; analyze the customer purchase history data stored in the business database to obtain a customer budget; and create a meal plan including a plurality of meals that collectively have a price falling within the customer budget, wherein each meal is defined by a recipe requiring items for carrying out the recipe.

In another embodiment of the present disclosure, a method for creating a meal plan is provided. The method utilizes a mobile computing device coupled to server computer of a business. The mobile computing device includes a memory for storing an application and a processor for executing the application. The server computer of the business is coupled to a business database for storing customer purchase history data and recipe data. While executing the application by the processor of the mobile computing device, the method comprises the steps of: identifying a customer; obtaining the customer purchase history data from the business database; analyzing the customer purchase history data to obtain a customer budget; and creating a meal plan including a plurality of meals that collectively have a price falling within the customer budget, wherein each meal is defined by a recipe requiring items for carrying out the recipe.

In another embodiment of the present disclosure, another method for creating a meal plan is provided. The method utilizes a mobile computing device coupled to server computer of a business and a server computer of a local store associated with the business. The mobile computing device includes a memory for storing an application and a processor for executing the application. The server computer of the business is coupled to a business database for storing recipe data, and the server computer of a local store associated with the business is coupled to a local store database for storing inventory data of the local store. The inventory data includes a current inventory of the local store and a current price for each item of the inventory of the local store. While executing the meal planning application by the processor of the mobile computing device, the method comprises the steps of: obtaining a customer budget; identifying a plurality of recipes from the recipe data stored in the business database, the identified recipes requiring items which are currently available at the local store based on the current inventory of the local store; determining a total price for each meal based on the current price of each item of the current inventory of the local store; and creating a meal plan including a plurality of meals collectively having a price falling within the customer budget, wherein each meal is defined by a recipe requiring items for carrying out the recipe.

In another embodiment of the present disclosure, one or more non-transitory computer-readable storage media for creating a meal plan is provided. The one or more non-transitory computer-readable storage media has computer-executable instructions embodied thereon and, when executed by a processor, causes the processor to: identify a customer; analyze the customer purchase history data to obtain a customer budget; and create a meal plan including a plurality of meals that collectively have a price falling within the customer budget, wherein each meal is defined by a recipe requiring items for carrying out the recipe.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a schematic illustrating an embodiment of a system for creating a meal plan.

FIG. 2 is a flowchart illustrating an embodiment of a method for creating a meal plan.

FIG. 3 is a flowchart illustrating another embodiment of a method for creating a meal plan.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment of example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments and/or examples in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present disclosure may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagram(s) in the flow diagram(s) illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

In addition, and for clarity in discussing the various functions of the system of the present disclosure, multiple server computers (or just computers or servers) are discussed as performing different functions. These different server computers may, however, be implemented in different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The functional terminology is used solely for purposes of naming convention and to distinguish one element from another in the following discussion. Unless otherwise specified, the name of an element conveys no specific functionality to the element or component.

With reference to the figures, and in operation, the present disclosure provides a system 10, methods, and one or more non-transitory computer-readable storage media for creating a meal plan. In some embodiments, the present disclosure describes creating a meal plan for a customer that fits within a customer budget automatically determined utilizing the customer's purchase history with a business. In other embodiments, the present disclosure describes creating a meal plan for a customer that fits within a customer budget and includes a plurality of meals with each meal being defined by a recipe requiring items or ingredients that are currently available at a local store associated with the business. Typically, each meal of the meal plan is packaged at the local store, and the packaging includes a recipe for preparing the meal and the items required by the recipe. The packaging may be available at the local store for pick up by the customer or may be delivered directly to the customer. Accordingly, the system 10, methods, and non-transitory computer-readable storage media advantageously enables a customer to obtain a meal plan based on his/her preferences (such as a daily meal plan, a weekly meal plan, etc.) and fits within the customer's budget. The system 10, methods, and non-transitory computer-readable storage media also advantageously simplifies planning for and preparing each meal, as each meal is packaged including a recipe with fresh ingredients from a local store and may be ready for pickup or delivered directly to the customer. Thus, the system 10, methods, and non-transitory computer-readable storage media provides a time and cost effective way to plan for and prepare meals for a customer having a tight daily schedule and limited resources. By preparing home cooked meals with fresh ingredients, the customer is also enjoying a healthier alternative to typical restaurant or take-out meals.

The term “meal plan” is used to describe a guideline for food that a person eats during a day, such as food for breakfast, food for lunch, and food for dinner. The meal plan may be constructed as a daily meal plan, which includes a breakfast meal, a lunch meal, and a dinner meal. In some instances, the daily meal plan may include a breakfast meal, a lunch meal, a dinner meal, and at least one of a snack, a desert, and a drink (such as a soda, juice, wine, a cocktail, etc.). Alternatively, the meal plan may be constructed as a weekly meal plan, which includes a breakfast meal, a lunch meal, and a dinner meal for each day of the week. In some instances, the weekly meal plan may include a breakfast meal, a lunch meal, a dinner meal, and at least one of a snack or a desert for each day of the week. Variations in the construction of the meal plan are also available. For instance, the meal plan can be constructed as a partial weekly meal plan that includes, e.g., a dinner meal for each day of the week. In another example, a partial weekly meal plan may include a breakfast meal, a lunch meal, and a dinner meal for the week days (e.g., Monday through Friday). In yet another example, a partial weekly meal plan may include a breakfast meal, a lunch, meal, and a dinner meal for the weekend days (e.g., Saturday and Sunday). As yet another alternative, the meal plan may be a monthly meal plan including, e.g., a breakfast meal, a lunch meal, and a dinner meal for each day of the month. It is to be appreciated that the meal plan can be constructed in any way desirable and may include any combination of days, weeks, months, and particular meals and the present disclosure is not limited to the specific examples of the meal plan identified above.

Additionally, the term “current” or “currently” is used to describe the existence of an item, price, etc. that existed at that moment in time. For example, an item that is “currently available” is an item that exists and is available at that moment in time. In another example, a “current inventory” of a store is the inventory of the store that exists at that moment of time. In yet another example, a “current price” of an item is the price of the item that exists at that moment in time.

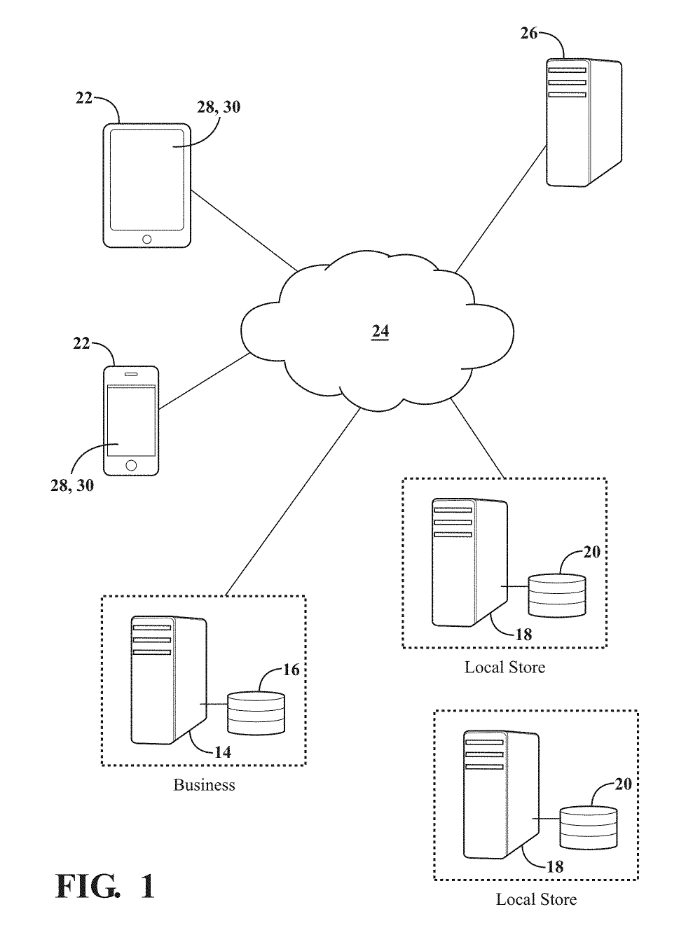

An example of the system 10 which is usable for creating a meal plan is shown in FIG. 1. It will be understood that the present disclosure, as generally described and illustrated in the figures, could be arranged and designed in a wide variety of different configurations. Thus, the following more detailed description of the embodiments of the present disclosure, as represented in the figures, is not intended to limit the scope of the present disclosure, as claimed, but is merely representative of certain examples of presently contemplated embodiments in accordance with the present disclosure. The presently described embodiments may be understood by reference to the figures, where like parts are designed by like numerals throughout.

Referring to the example set forth in FIG. 1, the system 10 includes business, such as a retail business. Examples of retail businesses include a clothing business, a grocery business, an office supply business, a furniture business, a toy/hobby business, and/or the like. In some examples, the business is a combination of retail businesses, such as a business which sells clothing and grocery, a business that sells office supply and furniture, etc. In one specific example of the present disclosure, the business is or includes a grocery business.

In an embodiment, the business is or includes a store, which is a physical establishment designed for the direct sale of goods to a customer. In another embodiment, the business is or includes a web-based store for the sale of goods to a customer through the Internet. In another embodiment, the business includes a central office (such as a headquarters) and a plurality of stores designed for the direct sale of goods to a customer. In yet another embodiment, the business includes a central office and a plurality of stores for the direct sale of goods to a customer as well as a web-based store for the sale of goods over the Internet. In embodiments where the business includes a plurality of stores, the business may include two, three, four . . . , hundreds, or even thousands of stores. Typically, the stores are located in various geographic locations, such as in different cities, in different towns, in different counties, on different streets or roads, on the same street but a mile or two away from one another, etc. Typically, one or more of the stores are considered to be local to a particular customer based on the customer's postal or residential address. These stores are referred to herein as local stores. In an example, a store is considered to be a local store when the store is located within a 0.5 mile radius of the customer's postal or residential address. In another example, a store is considered to be a local store when the store is located within a 1 mile radius of the customer's postal or residential address. In yet another example, a store is considered to be a local store when the store is located a within 5 mile radius of the customer's postal or residential address. The locality of a store is also based on how far a customer is willing to travel to go to the store. For example, one customer may be willing to travel up to 2 miles to go to a store, and therefore a store within a 2 mile radius of the customer's postal or residential address is considered to be a local store. However, another customer may be willing to travel up to 20 miles to go to a store, and therefore a store within a 20 mile radius of the customer's postal or residential address is considered to be a local store.

Still with reference to FIG. 1, system 10 includes a server computer 14 of the business (also referred to as a business server computer) and a business database 16 coupled to the business server computer 14. The system 10 further includes a server computer 18 of a local store (also referred to as a local store server computer) and a local store database 20 coupled to the local store server computer 18. The system 10 may include one, two, or more local stores depending on customer's current postal or residential address. As shown in the example depicted in FIG. 1, the system 10 includes two local stores.

The business server computer 14 includes a processor and a memory device connected to the business database 16 to retrieve and store information contained in the business database 16. Typically, the business server computer 14 and business database 16 are located at the central office of the business. Alternatively, the business server computer 14 and business database 16 may be located offsite (i.e., not at the central office), but are still considered to be part of the central office of the business.

The processor of the business server computer 14 executes various programs, and thereby controls components of the business server computer 14. The processor may be a single processor or a plurality of processors. Further, the processor may be a controller, a microcontroller, a microprocessor, an application specific integrated circuit (ASIC), or a processor working in conjunction with a central processing unit (CPU) performing the function of a general purpose computer. The processor of the business server computer 14 may be configured to execute computer programs containing computer-readable and executable instructions for performing a selected process. The memory coupled to the processor of the business server computer 14 may include a read only memory (ROM) and random access memory (RAM) for storing the computer-readable instructions of the computer programs. In embodiments where the business server computer 14 contains a plurality of processors, the processors can operate in parallel or distributed manner. In an example, the processor of the business server computer 14 may execute various modules of the system 10.

The memory of the business server computer 14 may be configured to store programs and information in the business database 16, and to retrieve information from the business database 16 that may be used by the processor of the business server computer 14 and/or an application of the customer's mobile computing device 22 to perform various steps of the method for creating a meal plan described herein. The memory may include, but is not limited to, a hard disc drive, an optical disc drive, and/or a flash memory drive.

The business database 16 contains, for example, customer profile data, customer purchase history data, and recipe data. The customer profile data includes identification information of a customer, such as the customer's name, residential or postal address, phone number, email address, and account information (such as credit card information, billing information, coupons, credits, etc.). In an embodiment, the customer profile data further includes customer preferences, such an identification of which stores that the customer prefers to shop at, food preferences (such as food items that the customer likes or dislikes), and health issues including, but not limited to, food allergies or intolerances (such as an allergy to shell fish, an intolerance to gluten, etc.), heart conditions (such as high blood pressure), high or low blood sugar, and/or the like. The customer profile data may be inputted by a clerk at one of the stores directly into the customer's profile. Alternatively, the customer profile data may be inputted by the customer by accessing the customer profile through a business website utilizing a suitable computing device having access to the Internet (such as a desktop computer, a laptop computer, a tablet computer, a smartphone, and/or the like). The customer profile data may also be inputted by the customer utilizing an application resident on the customer's mobile computing device 22. The information inputted by the clerk or the customer is automatically saved in the customer profile and stored in the business database 16.

The customer purchase history data includes information pertaining to the purchases made by the customer at one or more of the stores associated with the business. The purchase history information includes what items were purchased by the customer, when the items were purchased, how many of each item the customer purchased, how much the customer paid for each item purchased, and items returned by the customer and reasons why the items were returned, how often the customer purchases items from the store(s) associated with the business per week or per month, etc. The customer purchase history data may be obtained directly from the server computer of each of the stores of the business whenever the customer purchases goods from that store. For example, receipt data of the customer's purchase is automatically sent to the business server computer 14, which utilizes the receipt data to determine what items were purchased, how many of each item was purchased, etc. All of the information determined from the receipt data is then stored as customer purchase history of the customer in the business database 16.

The recipe data includes a plurality of recipes including recipes for preparing a breakfast meal, recipes for preparing a lunch meal, and recipes for preparing a dinner meal. In an example, the recipe data may further include recipes for preparing a snack, recipes for preparing a desert, and recipes for preparing a cocktail. The recipes may include recipes created by hired chefs, published recipes (e.g., recipes published by known professional chefs or organizations such as the Television Food Network), recipes created by the customer, and recipes created by other customers. Typically, the recipes created by hired chefs and published recipes are available to all of the customers. The recipes created by the customer may be available to all of the customers or just a limited number of customers based on the customer's preference. Utilizing the application resident on the customer's mobile computing device 22, the customer can, for example, input a recipe to be stored as recipe data in the business database 16 and the customer can indicate who is allowed to receive the recipe. For example, the customer can indicate that the recipe be used only for the customer, the customer can indicate that the recipe be used only for selected friends of the customer, or the customer can indicate that the recipe can be used for all customers. The indication of the customer's preference pertaining to the recipe is stored with the recipe in the business database 16. The recipes created by other customers may also be available to all customers or to a limited number of customers based on the other customers' preferences. For example, another customer can indicate that the recipe be used only for himself/herself, the other customer can indicate that the recipe be used only for friends of the other customer, or the other customer can indicate that the recipe can be used for all customers. The indication of the other customer's preference pertaining to the recipe is also stored with the recipe in the business database 16.

The local store server computer 18 includes a processor and a memory device connected to the local store database 20 to retrieve and store information contained in the local store database 20. The processor of the local store server computer 18 executes various programs, and thereby controls components of the local store server computer 18. The processor may be a single processor or a plurality of processors. Further, the processor may be a controller, a microcontroller, a microprocessor, an application specific integrated circuit (ASIC), or a processor working in conjunction with a central processing unit (CPU) performing the function of a general purpose computer. The processor of the local store server computer 18 may be configured to execute computer programs containing computer-readable and executable instructions for performing a selected process. The memory coupled to the processor of the business server computer 18 may include a read only memory (ROM) and random access memory (RAM) for storing the computer-readable instructions of the computer programs. In embodiments where the local store server computer 14 contains a plurality of processors, the processors can operate in parallel or distributed manner.

The memory of the local store server computer 18 may be configured to store programs and information in the local store database 20, and to retrieve information from the local store database 20 that may be used by the processor of the local server computer 18 and/or an application of the customer's mobile computing device 22 to perform various steps of the method for creating a meal plan as described herein. The memory may include, but is not limited to, a hard disc drive, an optical disc drive, and/or a flash memory drive.

The local store database 16 contains, for example, inventory data of the local store. The inventory data of the local store includes, for example, a current inventory of the store and a current price for each item of the inventory. The inventory of the local store is dynamically updated as goods are sold and/or stocked. Accordingly, the current inventory of the local store reflects the actual inventory of the store at that moment in time. Likewise, the store's price for each item of the current inventory is dynamically updated as prices for the item changes. Accordingly, the current price of each item of the current inventory of the store reflects the actual price for the item at that moment of time.

As shown in FIG. 1, the business server computer 14 and the local store server computer 18 are each coupled in communication to the mobile computing device 22 via a communications network 24. The communications network 24 may be any suitable connection, including the Internet, file transfer protocol (FTP), an Intranet, a local area network (LAN), a virtual private network (VPN), cellular networks, etc. Further, the communications network 24 may utilize any suitable or combination of technologies including, but not limited to, wired and wireless connections, always on connections, connections made periodically, and connections made when needed.

The mobile computing device 22 may include any suitable device that enables the customer to access and communicate with the system 10 including sending and/or receiving information to and from the system 10 and displaying information received from the system 10 to the customer. Examples of the mobile computing device 22 include, but are not limited to, a laptop or notebook computer, a tablet computer, a smartphone/tablet computer hybrid, a personal data assistant, a handheld mobile device including a cellular telephone, and/or the like. The mobile computing device 22, as well as any other connected computer systems and their components included in the system 10, can create message related data and exchange message related data (e.g., near field communication (NFC) payloads, Bluetooth packets, Internet Protocol (IP) datagrams, and other higher layer protocols that utilize IP diagrams, such as Transmission Control Protocol (TCP), Hypertext Transfer Protocol (HTTP), Simple Mail Transfer Protocol (SMTP), etc.) over the communications network 24.

In one embodiment, the mobile computing device 22 includes a smartphone such as an iPhone™. The mobile computing device 22 includes a processor coupled to a memory, and a database for storing various programs and data for use in operating the mobile computing device 22. The mobile computing device 22 may also include a display 28, one or more video image cameras, one or more speakers, a microphone, at least one input button, and one or more sensors including, but not limited to, a touch ID fingerprint sensor coupled to the input button, a barometer, a three-axis gyro, an accelerometer, a proximity sensor, and an ambient light sensor. The display 28 includes any type of device capable of displaying information to the customer utilizing the mobile computing device 22. An example of a display 28 includes a touchscreen display device. In addition, the mobile computing device 22 may include a Wi-Fi antenna, a cellular network antenna, a Bluetooth™ communications device, assisted GPS and GLONASS, a digital compass, and an iBeacon microlocation device.

In an embodiment, the mobile computing device 22 further includes a web browser stored in the memory. The processor of the mobile computing device 22 executes the web browser program to display webpages on the display 28 that includes information received from the business server computer 14 and/or the local store server computer 18 to enable the user to interact with and operate various functions associated with the server computers 14, 18. In addition, the mobile computing device 22 may be programmed to store and execute a mobile program application (i.e., an application) that displays a user interface 30 on the display 28 that allows the customer to access the business server computer 14 and/or the local store server computer 18 to retrieve and store information, as well as to interact with the server computers 14, 18 for performing the steps of the method for creating a meal plan described in further detail below.

The system 10 further includes a website host server 26 configured to host a website (such as the business website) that is accessible by the customer via any computing device having access to the Internet, such as the customer's mobile computing device 22. The website host server 26 retrieves and stores webpages associated with one or more websites in response to requests received from the customer via the mobile computing device 22. The webpage allows the customer to interact with the website and search and/or purchase goods via the website. The webpage also provides the customer with access to his/her customer profile stored in the business database 16 by entering an appropriate login and password. Upon accessing the customer profile, the customer can enter, change, or update customer profile information such as the customer's name, address, phone number, changes in health issues, customer likes and dislikes, etc.

Other features of the system 10 can be found in the following commonly owned U.S. patent applications, which are hereby incorporated by reference: U.S. patent application Ser. No. N/A, filed on Jan. 28, 2016 (Attorney Docket Number 068571.00242); U.S. patent application Ser. No. N/A, filed on Jan. 28, 2016 (Attorney Docket Number 068571.00243); U.S. patent application Ser. No. N/A, filed on Jan. 28, 2016 (Attorney Docket Number 068571.00244); US patent application Ser. No. N/A, filed on Jan. 28, 2016 (Attorney Docket Number 068571.00245); U.S. patent application Ser. No. N/A, filed on Jan. 28, 2016 (Attorney Docket Number 068571.00246); U.S. patent application Ser. No. N/A, filed on Jan. 28, 2016 (Attorney Docket Number 068571.00248); U.S. patent application Ser. No. N/A, filed on Jan. 28, 2016 (Attorney Docket Number 068571.00249); U.S. patent application Ser. No. N/A, filed on Jan. 28, 2016 (Attorney Docket Number 068571.00250); U.S. patent application Ser. No. N/A, filed on Jan. 28, 2016 (Attorney Docket Number 068571.00251); U.S. patent application Ser. No. N/A, filed on Jan. 28, 2016 (Attorney Docket Number 068571.00252); and, U.S. patent application Ser. No. N/A, filed on Jan. 28, 2016 (Attorney Docket Number 068571.00253).

Embodiments of a method for creating a meal plan are described in detail below. In each of these embodiments, the method steps may be performed utilizing an application for creating a meal plan (referred to herein as “the application”). The application is a computer program including computer-readable or -executable instructions stored in a non-transitory computer-readable medium that can direct a computing device or other programmable data processing apparatus to function in a particular manner, such that the instructions stored in the computer-readable or -executable medium produce an article of manufacture including instruction means which implement the function/act specified in the flowchart and/or block diagram block or blocks.

The instructions of the application may also be loaded onto a computing device or other programmable data processing apparatus to cause a series of operational steps to be performed on the computing device or other programmable data processing apparatus to produce a computer implemented process, such that the instructions which execute on the computing device or other programmable data processing apparatus provide processes for implementing the functions/acts specified in the flowchart and/or block diagram block or blocks.

In an example, the application may be loaded onto the customer's mobile computing device 22 to cause a series of operational steps to be performed for creating a meal plan. Upon entering appropriate authentication information (such as an appropriate login and password), the application performs a series of operational steps for creating a personalized meal plan for the customer. For instance, the application may create a meal plan for the user utilizing information provided by the customer (such as by entering the information into the application on the mobile computing device 22) and obtained from data stored in the business database 16 and the local store database 20. While executing instructions of the application, the application presents recipe options for the customer, where each recipe option defines a particular meal (such as a breakfast meal, a lunch meal, or a dinner meal) for the meal plan. The customer can select which recipes from the recipe options that he/she would like to include in the meal plan.

Alternatively, the customer can utilize the mobile computing device 22 (or any suitable computing device capable of connecting to the Internet) to access a business website retrieved or stored by the website host server 26. The business website includes a webpage driven by an application for creating a meal plan. Upon entering appropriate authentication information (such as an appropriate login and password) into a login screen of the webpage, the customer can access the application operable through the website for creating a meal plan. Similar to operating the application loaded or resident on the mobile computing device 22, the application can create a meal plan for the user utilizing information provided by the customer (such as by entering the information into webpage) and obtained from data stored in the business database 16 and the local store database 20. While executing instructions of the application, the webpage presents recipe options for the customer, and the customer can select which recipes from the recipe options presented on the webpage that he/she would like to include in the meal plan.

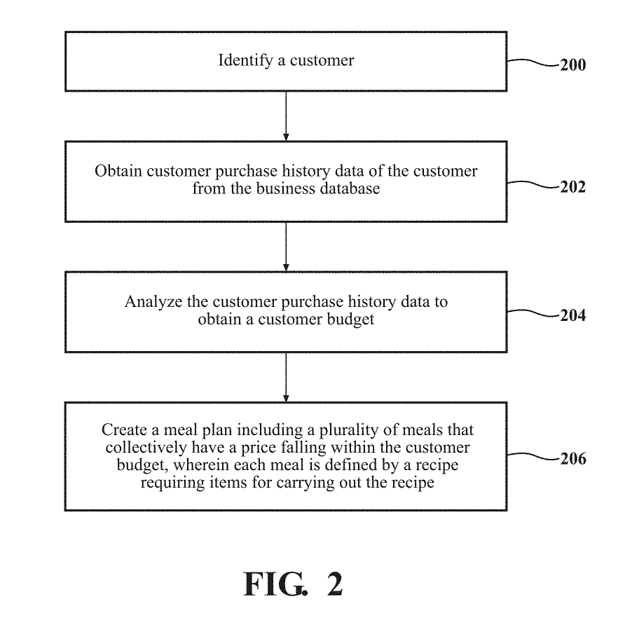

Referring now to FIG. 2, one embodiment of a method for creating a meal plan is described in detail below. This embodiment of the method utilizes the mobile computing device 22 including a memory for storing the application and a processor for executing the application. The mobile computing device 22 is coupled to the business server computer 14, and the business server computer 14 is coupled to the business database 16. The business database stores customer purchase history data, recipe data, and customer profile data as previously described. The method steps set forth in FIG. 2 are performed by executing the application by the processor of the mobile computing device 22. The method comprises the steps of identifying a customer (as shown in method step 200), obtaining customer purchase history data of the customer form the business database 16 (as shown in method step 202), analyzing the customer purchase history data to obtain a customer budget (as shown in method step 204), and creating the meal plan including a plurality of meals that collective have a price falling within the customer budget, wherein each meal is defined by a recipe requiring items for carrying out the recipe (as shown in method step 206).

As previously described, the customer can access the application loaded on the mobile computing device 22 by entering appropriate identification information into a login screen, such as a login name and password. In some instances, the user may also have to answer one or more challenge questions to ensure that the person logging into the application matches the account that the person is attempting to access. Examples of challenge questions include “What is your mother's maiden name?”, “What city were you born in?”, “What is the name of your first pet?”, and the like. The answers to these challenge questions were inputted by the customer at the time the customer set up his/her account. Upon entering the appropriate identification information, the customer is automatically identified by the application.

Upon identifying the customer, the mobile computing device 22 (by instructions from the application) submits a request to the business server computer 14 through the communications network 24 to obtain customer purchase history data stored in the business database 16. In an example, the mobile computing device 22 requests and therefore receives the entire customer purchase history data of the customer stored in the database 16. Via the application, the mobile computing device 22 analyzes the customer purchase history data of the customer to obtain a customer budget. For instance, the mobile computing device 22 analyzes each purchase that the customer has made from one or more stores associated with the business to determine what items were purchased and how much the customer paid for each item. The mobile computing device 22 also analyzes each purchase to determine a total amount of money that the customer paid for each purchase, and how often a purchase was made. Utilizing this information, the mobile computing device 22, via the application, can determine an approximate amount of money that the customer pays for each meal. For example, the customer purchase history data may reveal that the customer purchased chicken and potatoes at least once a week for a cost of $15 per purchase, and the customer purchased fish and rice at least one a week for a cost of $12 per purchase. Accordingly, the mobile computing device 22, via the application, may determine that the customer budget for a dinner meal ranges between $12 and $15. In another example, the customer purchase history data may reveal that the customer purchased lunch meats every week for a cost of $14, cheese every week for a cost of $5, bread every week for a cost of $4, condiments every week for a cost of $2, a bag of potato chips every week for $2, and soda every week for a cost of $6. Accordingly, the mobile computing device 22, via the application, may determine that the customer budget for a lunch meal ranges from $4 to $6.

To determine the customer budget, the application also takes into account items that are typically used for preparing a meal but are not frequently purchased by the customer, such as items purchased in large containers or in bulk such that such items are readily available to the customer whenever he/she needs them. For instance, the customer may purchase a condiment (such as ketchup and mustard) once every month or two, as a single container of the condiment typically lasts for longer than one serving. The application also takes into account the number of people that the customer may be shopping for. For example, the customer purchase history data may reveal that the customer purchased enough chicken to feed four people for an entire week for a cost of $45 for the chicken alone. While the customer may be buying the chicken in bulk and freezing what he/she does not eat right away, the application instruct the mobile computing device 22 to request customer profile data stored in the business database 16 for information indicating the number of people in the customer's household. Such information may also be used for determining the customer budget.

In an example, a budget for each meal of the day (e.g., a breakfast meal, a lunch meal, and a dinner meal) may be determined by the mobile computing device 22 via the application utilizing the customer purchase history data, and a customer budget for the whole meal plan is determined by adding up the budget for each meal of the day and the number of days that the meal plan covers. Utilizing the application on the mobile computing device 22, the customer can designate a number of days that the meal plan will cover. For example, the customer can designate that the meal plan is a daily meal plan, and therefore covers breakfast, lunch, and dinner meals for a single day. In another example, the customer can designate that the meal plan is a weekly meal plan, and therefore covers breakfast, lunch, and dinner meals for each day of a seven-day week. The customer can also tailor the meal plan to particular days and/or meals per days. For example, the customer can designate a meal plan covering Monday through Friday with only dinner meals, a meal plan covering Monday, Wednesday, and Friday with breakfast, lunch, and dinner meals, etc. Also utilizing the application on the mobile computing device 22, the customer can designate a number of people that the meal plan will cover. Utilizing the customer-designated meal plan and the customer-designated number of people that the meal plan will cover, the mobile computing device 22 via the application determines the customer budget for the whole meal plan.

In an alternative embodiment, upon receiving the request for the customer purchase history data from the mobile computing device 22, the business server computer 14 may perform the analysis of the customer purchase history data to obtain a customer budget and forward the customer budget to the mobile computing device 22. The mobile computing device 22 via the application may utilize the customer budget received from the business server computer 14 for creating a meal plan for the customer.

In an example, the method further includes obtaining recipe data from the business database 16, obtaining inventory data from the local store database 20, and identifying a plurality of recipes from the recipe data, where the identified recipes require items which are currently available at the local store based on the current inventory of the local store. The mobile computing device 22 may also request the customer profile data stored in the business database 16. As previously mentioned, the recipe data stored in the business database 16 includes a plurality of predefined or pre-formulated recipes. Each of the recipes stored in the business database 16 includes a list of items or ingredients and instructions for preparing a meal utilizing the list of items. Utilizing the customer's postal or residential address set forth in the customer profile data, the mobile computing device 22 via the application determines which stores associated with the business are local stores. For example, local stores may be determined by calculating a distance from the customer's postal or residential address to the local store and comparing the calculated distance with the distance that the customer is willing to travel to a store, as also set forth in the customer profile data. The store(s) falling within the distance that the customer is willing to travel is/are considered to be a local store(s).

Upon identifying the local store(s), the mobile computing device 22 via the application utilizing the inventory data of the local store(s) to determine the current availability of the items required by the recipes. Any recipe requiring an item that is not currently available by the local store(s) is excluded as a recipe option for the customer. The recipes identified as requiring items that are available at the local store(s) are included as recipe options for the meal plan. The customer can then select, utilizing the application on the mobile computing device 22, any of the recipe options to include in his/her meal plan.

In another example, the method includes obtaining recipe data from the business database 16, obtaining inventory data from the local store database 20, and identifying a plurality of recipes from the recipe data, with each of the identified recipes requiring items that collectively have a current price falling within the customer budget based on the current price of each item of the inventory of the local store. As previously mentioned, the recipe data stored in the business database 16 includes a plurality of recipes, and each of the recipes stored in the business database 16 includes a list of items and instructions for preparing a meal utilizing the items. In addition, the cost of each item required by a recipe typically depends on the current market price of the item, and the market price of food items tends to fluctuate. The total cost or price for a meal utilizing a particular recipe is therefore determined utilizing the current price of each of the items at the local store. Accordingly, upon identifying the local store(s) as described above, the mobile computing device 22 via the application reviews the current price for each item required by the recipes. Upon tallying up the total price for all of the items required by a recipe, the mobile computing device 22 identifies those recipes requiring items that collectively have a price (i.e., the total price for all items required by the recipe) falling within the customer budget. These recipes are then included as recipe options for the customer.

In another example, the method further includes obtaining recipe data from the business database 16 and obtaining customer purchase history data from the business database 16. The method further includes identifying a plurality of items that the customer has previously purchased based on the customer purchase history data of the customer. In an example, the mobile computing device 22 via the application scans the customer purchase history for items purchased by the customer since the customer started shopping at the stores associated with the business. In another example, the mobile computing device 22 scans the customer purchase history for items purchased by the customer during a predefined previous time period, such as during the past year, the past 6 months, the past 3 months, etc. Further, the mobile computing device 22 may identify items purchased by the customer a single time during the previous time period. Alternatively, the mobile computing device 22 may identify items purchased by the customer more than one time during the previous time period.

Upon identifying an item(s) previously purchased by the customer, the method further includes identifying a plurality of recipes from the recipe data with each of the identified recipes requiring items that the customer has previously purchased. For instance, the mobile computing device 22 via the application may have identified chicken as an item that was previously purchased by the customer. The mobile computing device 22 via the application may then identify a plurality of recipes from the recipe data containing chicken as one of the ingredients. The identified recipes (such as the recipes containing chicken from the example described above) are then included as a recipe options for the customer.

In another example, the method further includes obtaining customer profile data and recipe data from the business database 16 and inventory data from the local store database 20. In this example, the mobile computing device 22 via the application scans the customer profile data of the customer to identify food items that the customer has identified that he/she likes or dislikes. The mobile computing device 22 via the application then identifies a plurality of recipes from the recipe data which require at least one item that the customer likes, and includes the identified recipes as recipe options for the meal plan. Alternatively, the mobile computing device 22 via the application identifies at least one recipe from the recipe data which requires at least one item that the customer dislikes, and excludes the identified recipe(s) as a recipe option(s) for the meal plan.

In still another example, the method further includes obtaining customer profile data and recipe data from the business database 16 and inventory data from the local store database 20. In this example, the mobile computing device 22 via the application scans the customer profile data to identify at least one health issue of the customer. Examples of health issues of the customer include, but are not limited to, sugar diabetes, heart conditions including high blood pressure and high cholesterol, cancer, food allergies or intolerances, and/or the like. In instances where the customer has identified at least one health issue in the customer profile, the mobile computing device 22 via the application identifies at least one item that has a potential effect on the health issue(s) of the customer. For example, the mobile computing device 22 may identify red meats as having a potential effect on a heart condition of the customer. In another example, the mobile computing device 22 may identify pasta as having a potential effect on a customer with sugar diabetes. In yet another example, the mobile computing device 22 may identify wheat bread as having a potential effect on a customer with an allergy to gluten.

Items with a potential effect on the health issue of the customer may be identified by the customer in the customer profile. For instance, the customer may indicate certain food items that the customer cannot eat due to his/her health issue. Alternatively, the business database 16 may include an index of health issues and food items that has a potential effect on each of the health issues. Upon identifying the health issue(s) of the customer from the customer profile, the mobile computing device 22 via the application can obtain the index from the business database 16 to identify food items having a potential effect on the health issue(s).

Upon identifying food items that have a potential effect on the health issue(s) of the customer, the method includes identifying at least one recipe from the recipe data that requires at least one of the food items that has a potential effect on the health issue(s) of the customer, and excluding the identified recipe(s) as a recipe option(s) for the meal plan.

In an alternative example, the mobile computing device 22 via the application may identify potential health issue(s) of the customer from the customer profile, and identify at least one item that could improve the health issue. For example, the mobile computing device 22 may identify certain lean proteins, such as fish and chicken, for a customer having a heart condition. In another example, the mobile computing device 22 may identify certain cancer-fighting food items, such as green vegetables including spinach and kale, for a customer having cancer. In yet another example, the mobile computing device 22 may identify certain low-sugar food items for a customer with sugar diabetes. Upon identifying item(s) that could improve the health issue, the method includes identifying at least one recipe requiring at least one of the items identified as potentially improving the health issue, and including the identified recipe(s) as a recipe option(s) for the meal plan.

In an example, the method further includes the steps of presenting the plurality of recipe options on the display 28 of the mobile computing device 22, obtaining a selection of at least one of the recipe options for each meal, and incorporating the selected recipe option for each meal into the meal plan. The plurality of recipes presented to the customer includes the recipes identified by the mobile computing device 22 via the application that collectively have a price falling within the customer budget. For instance, a plurality of breakfast recipes for a breakfast meal may be presented to the customer on the display 28 of the mobile computing device 22, a plurality of lunch recipes for a lunch meal may be presented to the customer on the display 28 of the mobile computing device 22, and a plurality of dinner recipes for a dinner meal may be presented to the customer on the display 28 of the mobile computing device 22. In instances where the customer selects a daily meal plan, the customer selects one of the breakfast recipes for the breakfast meal, one of the lunch recipes for the lunch meal, and one of the dinner recipes for the dinner meal. In instances where the customer selects a seven-day weekly meal plan, the customer selects seven breakfast recipes for the seven breakfast meals, seven lunch recipes for the seven lunch meals, and seven dinner recipes for the seven dinner meals. The application enables the customer to tailor his/her meal plan, such as by selecting the same breakfast recipe for more than one breakfast meal, the same lunch recipe for more than one lunch meal, and the same dinner recipe for more than one dinner meal. Alternatively, the customer can select a different recipe for each meal. The customer can also select more than one breakfast, lunch, or dinner recipe for a single day. For example, the customer may select a breakfast recipe for a breakfast meal, another breakfast recipe for a lunch meal on the same day, and a dinner recipe for a dinner meal on the same day. Selection of the recipes for creating the meal plan may be accomplished using the user interface 30 of the mobile computing device 22, such as by selecting (via, e.g., a finger touch on a touchscreen display) of an icon representing the recipe. The customer can drag the recipe icon to a desired meal slot on a calendar displayed on the display 28 of the device 22. Selection of the recipes may otherwise be accomplished by selecting (via, e.g., a finger touch on a touchscreen display) of a meal slot on a calendar displayed on the device 22 to activate a menu including recipe options for the customer, and selecting the recipe from the menu options. Other ways of selecting recipes for creating the meal plan that are not specifically described above are also contemplated herein.

Once the meal plan is created, the mobile computing device 22 automatically transmits the meal plan to the local store server computer 18 of one of the local stores utilizing the communications network 24. In addition to the recipes set forth in each meal slot, the meal plan further includes dates for when the meal plan starts (i.e., the first day of the meal plan) and ends (i.e., the last day of the meal plan). The local store schedules a day and time for packaging the recipes and required food items prior to the first day of the meal plan. In an example, each meal may be packaged in its own box and includes a recipe with explicit instructions for preparing the meal along with suitable diagrams or pictures, and all of the items required for preparing the meal. The items may be packaged individually, such as by plastic wrapping or vacuum wrapping for maintaining freshness and placed into the box. The plurality of boxes, with a meal in each box, may for example be placed into a larger box containing all of the means for the meal plan. In one example, the box may be shipped directly to the customer's residence at least one day prior to when the meal plan starts. In another example, the box may be available at the local store for pick up by the customer at least one day prior to when the meal plan starts.

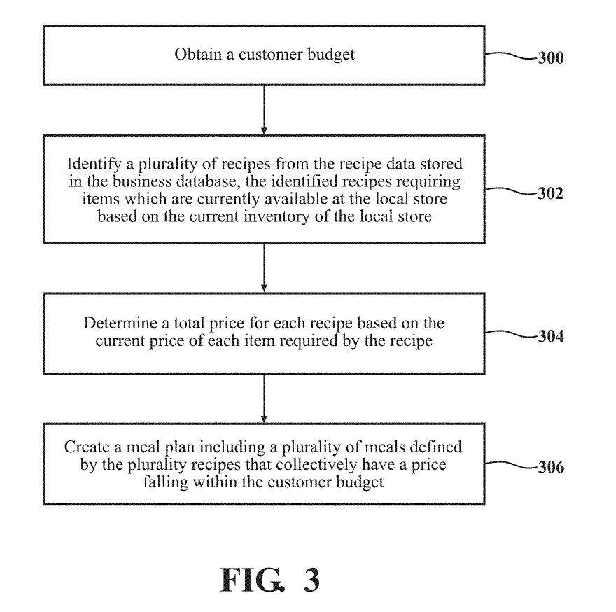

Another embodiment of a method for creating a meal plan is described below with reference to FIG. 3. This embodiment of the method utilizes the mobile computing device 22 including a memory for storing the application and a processor for executing the application. The mobile computing device 22 is coupled to the business server computer 14 and the local store server computer 18. The business server computer 14 is coupled to the business database 16 for storing recipe data and customer purchase history data as previously described. The local store server computer 18 is coupled to the local store database 20 for storing inventory data of the local store. As previously described, the inventory data includes a current inventory of the local store and a current price for each item of the inventory of the local store. The method steps set forth in FIG. 3 are performed by executing the application by the processor of the mobile computing device 22.

The method comprises the step of obtaining a customer budget (as shown in method step 300). In an example, the customer budget may be obtained by identifying a customer and analyzing the customer purchase history data of the identified customer as previously described. In another example, utilizing the user interface 30 of the mobile computing device 22, the customer may input a customer budget directly into the application. The customer can input a customer budget for each meal plan that the customer creates. Alternatively, the customer budget can by input once and stored by the application until the customer changes the budget. The stored budget can then be applied for each meal plan that the customer creates.

The method further includes identifying a plurality of recipes from the recipe data stored in the business database, the identified recipes requiring items which are currently available at the local store based on the current inventory of the local store (as shown in method step 302), determining a total price for each meal based on the current price of each item of the inventory of the local store (as shown in method step 304), and creating a meal plan including a plurality of meals that collective have a price falling within the customer budget, wherein each meal is defined by a recipe requiring items for carrying out the recipe (as shown in method step 306). Details for the identifying steps, the determining step, and the creating step are described above with reference to the embodiment of the method described with reference to FIG. 2.

Several embodiments and/or examples of a method for creating a meal plan are described above utilizing an application loaded or resident on the mobile computing device 22. It is to be understood that the embodiments and/or examples of the method may alternatively be performed utilizing any suitable computing device, which is not necessarily mobile. For example, the methods may be performed utilizing a desktop computer, a laptop computer, a notebook computer, and/or the like. It is further to be understood that the embodiments and/or examples of the method may be accomplished by accessing the business website via the Internet and creating a meal plan utilizing a meal planning webpage. Other variations of the embodiments and/or examples of the method understood by those skilled in the art which are not specifically mentioned above are also contemplated herein.

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure.

What is claimed is:

1. A system for creating a meal plan comprising:
a server computer of a business;
a business database coupled to the server computer of the business for storing customer purchase history data and recipe data; and
a mobile computing device coupled to the server computer of the business with the mobile computing device including:
a memory for storing an application containing computer-executable instructions; and
a processor coupled to the memory for executing the computer-executable instructions of the application, the executing of the computer-executable instructions causing the processor to:
identify a customer;
obtain customer purchase history data of the customer from the business database;
analyze the customer purchase history data to obtain a customer budget; and
create a meal plan including a plurality of meals that collectively have a price falling within the customer budget, wherein each meal is defined by a recipe requiring items for carrying out the recipe.

2. The system as set forth in claim 1 further comprising:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the inventory data from the local store database;
obtain recipe data from the business database;
identify a plurality of recipes from the recipe data, the identified recipes requiring items which are currently available at the local store based on the current inventory of the local store; and
include the identified recipes as recipe options for the meal plan.

3. The system as set forth in claim 1 further comprising:
a server computer of a local store associated with the business; and
a local store database coupled to the server computer of the local store for storing inventory data of the local store, wherein the inventory data includes a current price for each item of the inventory of the local store;
wherein the processor is configured to execute the computer-executable instructions of the application which causes the processor to:
obtain the inventory data from the local store database;
obtain the recipe data from the business database;
identify a plurality of recipes from the recipe data, with each of the identified recipes requiring items that collectively have a current price falling within the customer budget based on the current price of each item of the inventory of the local store; and
include the identified recipes as recipe options for the meal plan.

4. The system as set forth in claim 1 further comprising:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the customer purchase history data of the customer and from the business database;
obtain the recipe data from the business database;
obtain the inventory data of the local store from the local store database;
identify a plurality of items that are currently available at the local store that the customer has previously purchased;
identify at least one recipe from the recipe data that requires the at least one item that the customer has previously purchased; and
include the identified recipe as a recipe option for the meal plan.

5. The system as set forth in claim 1 wherein the business database further includes customer profile data including an identification of at least one item that the customer likes and the system further comprises:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the customer profile data of the customer from the business database;
obtain the recipe data from the business database;
obtain the inventory data from the local store database;
identify a plurality of items that are currently available at the local store that the customer likes;
identify a plurality of recipes from the recipe data, with each identified recipe requiring at least one item that the customer likes; and
include the identified recipes as recipe options for the meal plan.

6. The system as set forth in claim 1 wherein the business database further includes customer profile data including an identification of at least one item that the customer dislikes and the system further comprises:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the customer profile data of the customer from the business database;
obtain the recipe data from the business database;
obtain the inventory data from the local store database;
identify a plurality of items that are currently available at the local store that the customer dislikes;
identify at least one recipe from the recipe data that requires at least one of the items that the customer dislikes; and
excluding the identified recipe as a recipe option for the meal plan.

7. The system as set forth in claim 1 wherein the business database further includes customer profile data including an identification of at least one health issue of the customer and the system further comprises:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the customer profile data of the customer from the business database;
obtain the recipe data from the business database;
identify the at least one health issue of the customer from the customer profile data;
identify at least one item that has a potential effect on the at least one health issue of the customer;
identify at least one recipe from the recipe data that requires an item that has a potential effect on the at least one health issue of the customer; and
excluding the identified recipe as a recipe option for the meal plan.

8. The system as set forth in claim 1 wherein the business database further includes customer profile data including an identification of at least one health issue of the customer and the system further comprises:
a server computer of a local store associated with the business; and
a local store database coupled to the server computer of the local store for storing inventory data of the local store, wherein the inventory data includes a current inventory of the local store;
wherein the processor is configured to execute the computer-executable instructions of the application which causes the processor to:
obtain the customer profile data of the customer from the business database;
obtain the recipe data from the business database;
identify the at least one health issue of the customer from the customer profile data;
identify at least one item that has a potential improvement on the at least one health issue of the customer;
identify at least one recipe from the recipe data that requires an item that has a potential improvement on the at least one health issue of the customer; and
include the identified recipe as a recipe option for the meal plan.

9. The system as set forth in claim 1 wherein the mobile computing device includes a display, and wherein the processor is configured to execute the computer-executable instructions of the application which causes the processor to:
present a plurality of recipe options on the display;
obtain a selection of at least one of the recipe options for each meal; and
incorporate the selected recipe options into the meal plan.

10. The system as set forth in claim 1 wherein the recipe data includes a plurality of recipes chosen from at least one recipe created by a chef, at least one recipe created by the customer, at least one recipe created by a friend of the customer, at least one recipe created by a third party, and combinations thereof

11. The system as set forth in claim 1 wherein the meal plan is a weekly meal plan including a breakfast meal, a lunch meal, and a dinner meal for each day of the week.

12. A method of creating a meal plan with said method utilizing a mobile computing device coupled to a server computer of a business, the mobile computing device including a memory for storing an application and a processor for executing the application and server computer of the business is coupled to a business database for storing customer purchase history data and recipe data, and while executing the application by the processor of the mobile computer device, said method comprises the steps of:
identifying a customer;
obtaining customer purchase history data of the customer from the business database;
analyzing the customer purchase history data to obtain a customer budget; and
creating a meal plan including a plurality of meals that collectively have a price falling within the customer budget, wherein each meal is defined by a recipe requiring items for carrying out the recipe.

13. The method as set forth in claim 12 wherein the mobile computing device is further coupled to a server computer of a local store associated with the business, the server computer of the local store being coupled to a local store database for storing inventory data of the local store, the inventory data including a current inventory of the local store, and wherein the step of creating the meal plan includes the steps of:
obtaining the inventory data from the local store database;
obtaining recipe data from the business database;
identifying a plurality of recipes from the recipe data, the identified recipes requiring items which are currently available at the local store based on the current inventory of the local store; and
including the identified recipes as recipe options for the meal plan.

14. The method as set forth in claim 12 wherein the mobile computing device is further coupled to a server computer of a local store associated with the business, the server computer of the local store being coupled to a local store database for storing inventory data of the local store, the inventory data including a current price for each item of the inventory of the local store, and wherein the step of creating the meal plan includes the steps of:
obtaining the inventory data from the local store database;
obtaining recipe data from the business database;
identifying a plurality of recipes from the recipe data, with each of the identified recipes requiring items that collectively have a current price falling within the customer budget based on the current price of each item of the inventory of the local store; and
including the identified recipes as recipe options for the meal plan.

15. The method as set forth in claim 12 wherein the mobile computing device is further coupled to a server computer of a local store associated with the business, the server computer of the local store being coupled to a local store database for storing inventory data of the local store, the inventory data including a current inventory of the local store, and wherein the step of creating the meal plan includes the steps of:
obtaining the customer purchase history data of the customer from the business database;
obtaining the recipe data from the business database;
obtaining the inventory data of the local store from the local store database;
identifying a plurality of items that are currently available at the local store that the customer has previously purchased;
identifying a plurality of recipes from the recipe data, with each identified recipe requiring at least one item that the customer has previously purchased; and
including the identified recipes as recipe options for the meal plan.

16. The method as set forth in claim 12 wherein the mobile computing device is further coupled to a server computer of a local store associated with the business, the server computer of the local store being coupled to a local store database for storing inventory data of the local store, the inventory data including a current inventory of the local store and the business database further includes customer profile data including an identification of at least one item that the customer likes, and wherein the step of creating the meal plan includes the steps of:
obtaining the customer profile data of the customer from the business database;
obtaining the recipe data from the business database;
obtaining the inventory data of the local store from the local store database;
identifying a plurality of items that are currently available at the local store that the customer likes;
identifying a plurality of recipes from the recipe data, with each identified recipe requiring at least one item that the customer likes; and
including the identified recipes as recipe options for the meal plan.

17. The method as set forth in claim 12 wherein the mobile computing device is further coupled to a server computer of a local store associated with the business, the server computer of the local store being coupled to a local store database for storing inventory data of the local store, the inventory data including a current inventory of the local store and the business database further includes customer profile data including an identification of at least one item that the customer dislikes, and wherein the step of creating the meal plan includes the steps of:
obtaining the customer profile data of the customer from the business database;
obtaining the recipe data from the business database;
obtaining the inventory data of the local store from the local store database;
identifying a plurality of items that are currently available at the local store that the customer dislikes;
identifying at least one recipe from the recipe data that requires at least one of the items that the customer dislikes; and
excluding the at least recipe from the meal plan.

18. The method as set forth in claim 12 wherein the mobile computing device is further coupled to a server computer of a local store associated with the business, the server computer of the local store being coupled to a local store database for storing inventory data of the local store, the inventory data including a current inventory of the local store and the business database includes customer profile data including an identification of at least one health issue of the customer, and wherein step of creating the meal plan includes the steps of:
obtaining the customer profile data of the customer from the business database;
obtaining the inventory data from the local store database;
obtaining the recipe data from the business database;
identifying the at least one health issue of the customer from the customer profile data;
identifying at least one item that has a potential effect on the at least one health issue of the customer;
identifying at least one recipe from the recipe data that requires the at least one item that has a potential effect on the at least one health issue of the customer; and
excluding the at least one recipe from the meal plan.

19. The method as set forth in claim 12 wherein the mobile computing device is further coupled to a server computer of a local store associated with the business, the server computer of the local store being coupled to a local store database for storing inventory data of the local store, the inventory data including a current inventory of the local store and the business database includes customer profile data including an identification of at least one health issue of the customer, and wherein step of creating the meal plan includes the steps of:
obtaining the customer profile data of the customer from the business database;
obtaining the recipe data from the business database;
identifying the at least one health issue of the customer from the customer profile data;
identifying at least one item that has a potential improvement on the at least one health issue of the customer;
identifying at least one recipe from the recipe data that requires an item that has a potential improvement on the at least one health issue of the customer; and
including the identified recipe as a recipe option for the meal plan.

20. The method as set forth in claim 12 wherein the mobile computing device includes a display and the method further comprises the steps of:
presenting a plurality of recipe options on the display;
obtaining a selection of at least one of the recipe options for each meal; and
incorporating the selected recipe options into the meal plan.

21. The method as set forth in claim 12 wherein after the step of creating the meal plan, the method further comprises the step of packaging each meal of the meal plan such that each packaged meal includes the recipe and the items required by the recipe.

22. A method of creating a meal plan with said method utilizing a mobile computing device coupled to a server computer of a business and a server computer of a local store associated with the business, the mobile computing device including a memory for storing an application and a processor for executing the application, the server computer of the business being coupled to a business database for storing recipe data, and the server computer of the local store associated with the business being coupled to a local store database for storing inventory data of the local store, the inventory data including a current inventory of the local store and a current price for each item of the inventory of the local store, and while executing the application by the processor of the mobile computer device, said method comprises the steps of:
obtaining a customer budget;
identifying a plurality of recipes from the recipe data stored in the business database, the identified recipes requiring items which are currently available at the local store based on the current inventory of the local store;
determining a total price for each of the plurality of recipes based on the current price of each item required by each of the recipes; and
creating a meal plan including a plurality of meals defined by the plurality of recipes that collectively have a price falling within the customer budget.

23. The method as set forth in claim 22 wherein the mobile computing device further includes a user interface, and wherein the step of obtaining the customer budget includes inputting the customer budget into the application utilizing the user interface of the mobile computing device.

24. The meal planning method as set forth in claim 22 wherein the business database further stores customer purchase history data, and wherein the step of obtaining a customer budget includes the steps of:
identifying a customer; and
analyzing the customer purchase history data of the identified customer to obtain the customer budget.

25. One or more non-transitory computer-readable storage media having computer-executable instructions embodied thereon and, when executed by a processor, causes the processor to:
identify a customer;
analyze customer purchase history data to obtain a customer budget; and
create a meal plan including a plurality of meals that collectively have a price falling within the customer budget, wherein each meal is defined by a recipe requiring items for carrying out the recipe.
